(19) United States
(12) Patent Application Publication
(10) Pub. No.: US 2020/0105120 A1
(43) Pub. Date: Apr. 2, 2020

(54) EMERGENCY DETECTION AND NOTIFICATION SYSTEM

(71) Applicant: International Business Machines Corporation, Armonk, NY (US)

(72) Inventors: John S. Werner, Fishkill, NY (US); Byron S. Green, Poughkeepsie, NY (US); Arkadiy O. Tsfasman, Wappingers Falls, NY (US); William L. Brodsky, Binghamton, NY (US); Robert K. Mullady, Ulster, NY (US); Jeffrey A. Newcomer, Poughkeepsie, NY (US)

(21) Appl. No.: 16/144,203

(22) Filed: Sep. 27, 2018

(51) Int. Cl. G08B 25/00; G10L 15/08; H04N 7/18

(52) U.S. Cl. CPC G08B 25/006; G10L 15/08; G10L 2015/088; H04N 7/185; H04N 7/188

(57) ABSTRACT

Embodiments include methods, systems, and computer program products for determining that an emergency situation is occurring. The computer-implemented method includes receiving, using a processor, audio and/or video data from a user device. The processor further analyzes the audio and/or video data for triggers indicating that an emergency is occurring. The processor further determines that an emergency is occurring in response to the analysis indicating a trigger within the audio and/or video data.

### BACKGROUND

The present invention relates in general to emergencies and more specifically, to detecting emergencies and requesting assistance in response to an emergency.

An estimated 240 million calls are made to 911 in the U.S. each year. A large portion of these calls are requests for assistance from emergency medical services or local authorities (i.e., police). Many of calls to 911 are in response to a crime being committed or an accident. Many of these situations may be time sensitive where late arrival from emergency medical services or local authorities could be the difference between life and death. In some situations, a criminal may never be apprehended due to lack of evidence.

### SUMMARY

Embodiments of the invention are directed to a method for determining that an emergency situation is occurring. A non-limiting example of the computer-implemented method includes receiving, using a processor, audio and/or video data from a user device. The processor further analyzes the audio and/or video data for triggers indicating an emergency. The processor further determines that an emergency is occurring in response to the analysis indicating a trigger within the audio and/or video data.

Embodiments of the invention are directed to a computer program product that can include a storage medium readable by a processing circuit that can store instructions for execution by the processing circuit for performing a method for determining that an emergency situation is occurring. The method includes receiving audio and/or video data from a user device. The processor further analyzes the audio and/or video data for triggers indicating an emergency. The processor further determines that an emergency is occurring in response to the analysis indicating a trigger within the audio and/or video data.

Embodiments of the invention are directed to a system. The system can include a processor in communication with one or more types of memory. The processor can be configured to receive audio and/or video data from a user device. The processor can be configured to analyze the audio and/or video data for triggers indicating an emergency. The processor can be configured to determine that an emergency is occurring in response to the analysis indicating a trigger within the audio and/or video data.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The foregoing and other features, and advantages of the disclosure are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram illustrating one example of a processing system for practice of the teachings herein;

FIG. 4 is a block diagram illustrating a computing system according to one or more embodiments of the present invention; and

FIG. 5 is a flow diagram of a method for determining and providing an alert notification that an emergency is occurring according to one or more embodiments of the present invention.

The diagrams depicted herein are illustrative. There can be many variations to the diagram or the operations described therein without departing from the spirit of the invention. For instance, the actions can be performed in a differing order or actions can be added, deleted, or modified. In addition, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments of the invention, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, embodiments of the invention are related in general to emergency management. Often, in an emergency situation, a person involved in the emergency situation is the individual that calls 911. There are instances in which the emergency is the result of a crime that was perpetrated against an individual or the individual is involved in an accident. In both instances, the individual may not be able to call 911 due to incapacity or a variety of other reasons. Accordingly, there could be a delay in rendering aid to the individual, which could be life-threatening.

Turning now to an overview of the aspects of the invention, one or more embodiments of the invention address the above-described shortcomings of the prior art by actively monitoring an individual's user device to obtain verbal information and sounds within a proximity of the user device. The obtained verbal information and sounds can be analyzed to determine if the individual is involved in an emergency situation. If the analysis indicates that the individual is involved in an emergency, local authorities, emergency services, and emergency contacts can be contacted without the input of the individual.

The above-described aspects of the invention address the shortcomings of the prior art by actively monitoring an individual's user device to determine whether the individual is involved in an emergency and contacting local authorities and/or emergency services to render assistance to the individual. Accordingly, time can be saved when rendering aid to the individual thereby improving the chances of avoiding serious or life-threatening injuries.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud-computing environment is service oriented with a focus on statelessness, low coupling, modularity, and semantic interoperability. At the heart of cloud computing is an infrastructure comprising a network of interconnected nodes.

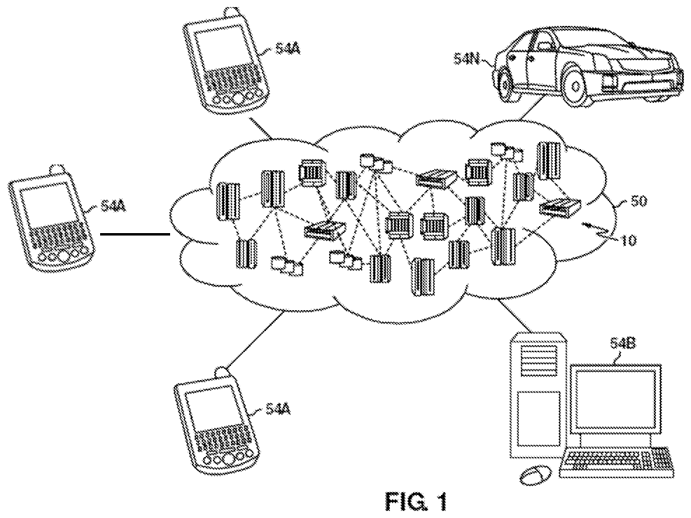

Referring now to FIG. 1, illustrative cloud computing environment 50 is depicted. As shown, cloud-computing environment 50 comprises one or more cloud computing nodes 10 with which local computing devices used by cloud consumers, such as, for example, personal digital assistants (PDA) or cellular telephones 54A (mobile devices), desktop computer 54B, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud-computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

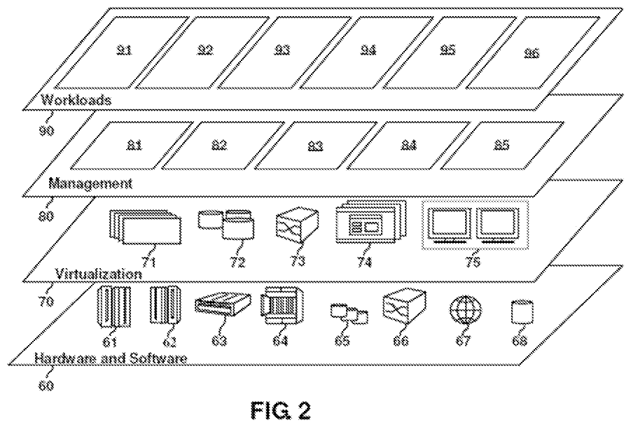

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud-computing environment. Metering and Pricing 82 provide cost tracking as resources are utilized within the cloud-computing environment, and billing or invoicing for consumption of these resources. In one example, these resources may comprise application software licenses. Security provides identity verification for cloud consumers and tasks, as well as protection for data and other resources. User portal 83 provides access to the cloud-computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions that may be provided from this layer include: mapping and navigation 91; software development and lifecycle management 92; virtual classroom education delivery 93; data analytics processing 94; transaction processing 95; and emergency detection and response management 96. Embodiments described herein can be performed in a non-cloud-computing environment.

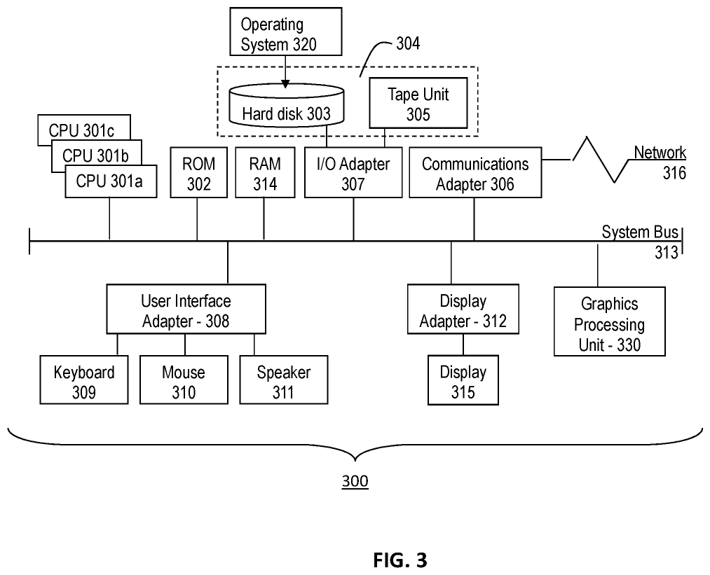

Referring to FIG. 3, there is shown a processing system 300 for implementing the teachings of the present disclosure according to one or more embodiments of the invention described herein. The system 300 has one or more central processing units (processors) 301a, 301b, 301c, etc. (collectively or generically referred to as processor(s) 301). In one embodiment, each processor 301 may include a reduced instruction set computer (RISC) microprocessor. Processors 301 are coupled to system memory 314 and various other components via a system bus 313. Read only memory (ROM) 302 is coupled to the system bus 313 and may include a basic input/output system (BIOS), which controls certain basic functions of system 300.

FIG. 3 further depicts an input/output (I/O) adapter 307 and a communications adapter 306 coupled to the system bus 313. I/O adapter 307 may be a small computer system interface (SCSI) adapter that communicates with a hard disk 303 and/or tape storage drive 305 or any other similar component. I/O adapter 307, hard disk 303, and tape storage device 305 are collectively referred to herein as mass storage 304. Operating system 320 for execution on the processing system 300 may be stored in mass storage 304. A communications adapter 306 interconnects bus 313 with an outside network 316 enabling data processing system 300 to communicate with other such systems. A screen (e.g., a display monitor) 315 is connected to system bus 313 by display adapter 312, which may include a graphics adapter to improve the performance of graphics intensive applications and a video controller. In one embodiment, adapters 307, 306, and 312 may be connected to one or more I/O busses that are connected to system bus 313 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 313 via user interface adapter 308 and display adapter 312. A keyboard 309, mouse 310, and speaker 311 all interconnected to bus 313 via user interface adapter 308, which may include, for example, a Super I/O chip integrating multiple device adapters into a single integrated circuit.

In exemplary embodiments of the invention, the processing system 300 includes a graphics-processing unit 330. Graphics processing unit 330 is a specialized electronic circuit designed to manipulate and alter memory to accelerate the creation of images in a frame buffer intended for output to a display. In general, graphics-processing unit 330 is very efficient at manipulating computer graphics and image processing and has a highly parallel structure that makes it more effective than general-purpose CPUs for algorithms where processing of large blocks of data is done in parallel.

Thus, as configured in FIG. 3, the processing system 300 includes processing capability in the form of processors 301, storage capability including system memory 314 and mass storage 304, input means such as keyboard 309 and mouse 310, and output capability including speaker 311 and display 315. In one embodiment, a portion of system memory 314 and mass storage 304 collectively store an operating system such as the AIX® operating system from IBM Corporation to coordinate the functions of the various components shown in FIG. 3.

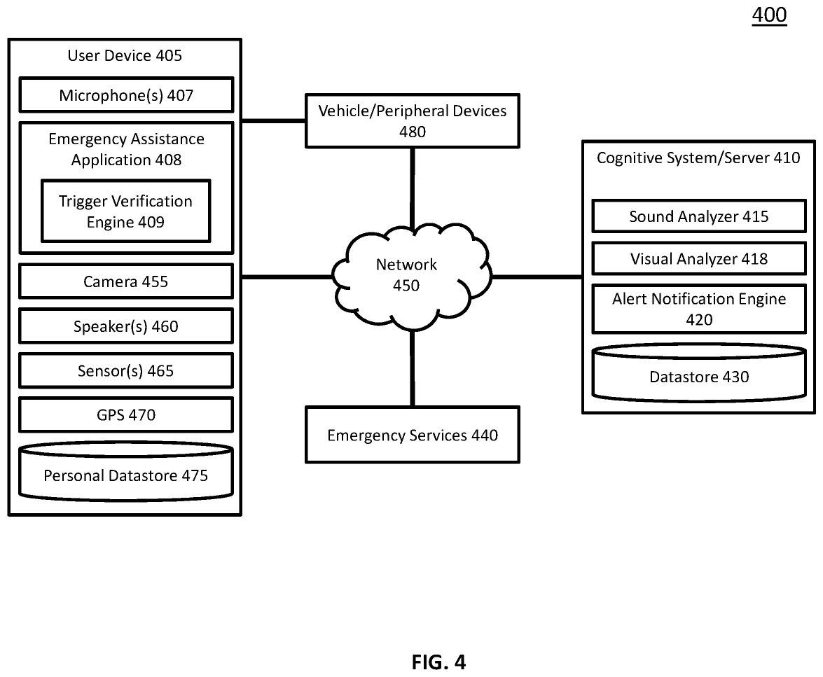

Referring now to FIG. 4, there is illustrated a computing system 400 in accordance with one or more embodiments of the invention. As illustrated, the computing system 400 can include but is not limited to, one or more user devices 405, a cognitive system/server 410, which can include a sound analyzer 415, visual analyzer 418, an alert notification engine 420 and a datastore 430 connected over one or more networks, for example, network 450. The datastore 430 can store sounds and/or images which can be used to train the cognitive system/server 410 to recognize emergency situations, contact information for emergency services based on GPS location, user profiles that can contain voice signatures, etc. One or more emergency services 440 (e.g., police, fire rescue, emergency medical services (EMS), etc.) can be connected to the computing system 410 over the one or more networks 450.

The one or more user devices 405 can be any type of computing device, such as a computer, laptop, tablet, smartphone, wearable computing device, personal assistant (e.g., Siri, Bixby, Alexa, Cortana, or the like), etc. The user device 405 can be operably coupled with a vehicle, which may be autonomous or semi-autonomous, or another computing or peripheral device 480. Each user device 405 can include a camera 455, a microphone 407, one or more speakers 460, GPS 470, and personal datastore 475. The microphone and camera of each user device can be activated by, for example, an emergency assistance application 408 stored on the user device 405. A user can use the emergency assistance application 408 to instruct an associated user device 405 to monitor the user and a current environment of the user. The emergency assistance application 408 can use the microphone and/or camera to obtain input which can be used to determine if the user is in an emergency situation.

Each user device 405 can also include one or more sensors 465. The sensors can include one or more accelerometers, motion detectors, orientation detectors, gyroscopes, or other sensors, which can sense physical activity such as standing, falling, moving, exercising, etc. Each user device 405 can also include sensors that measure biometrics such as heartrate and other physiological information as additional inputs to determine if a user is in an emergency situation.

The emergency assistance application for each user device 405 can communicate with the cognitive system/server 410 over one or more networks 450. Each user device 405 can be tailored to a specific user or group of users (e.g., family). The associated user device 405 can learn the user's speech patterns, accent, intonation, and other mannerisms.

The emergency assistance application 408 for each user device 405 can include a trigger verification analyzer 409, which can perform a preliminary determination of whether an emergency situation is occurring. The trigger verification analyzer 409 can include a speech processing application. The trigger verification analyzer 409 can analyze speech data and any associated background sounds obtained from the user device 405 to determine whether an emergency situation is occurring. The speech and sound data can be compared to words and/or sounds often associated with an emergency (e.g., “help me”, an elevated voice, scream, broken glass, gunshot, car crash, etc.) and/or duress (e.g., “I will do anything you say”, “please do not hurt me”). A repository of emergency words may be stored on the user device 405 and/or a personal datastore 475. The trigger verification analyzer 409 can also contain video recognition software, which can be used to analyze camera data from an associated user device 405. The trigger verification analyzer 409 can also utilize any associated sensor data and/or biometric data in the analysis of determining whether an emergency situation is occurring. The trigger verification analyzer 409 is designed to be sensitive and may be triggered even when an emergency is not occurring. Accordingly, the cognitive system/server 410 can perform further analysis to determine if the data sent from the emergency assistance application 408 indicates a true emergency (e.g., while reading a paragraph from a suspense novel aloud, the user device 405 could detect a trigger phrase “help me”, and accordingly send audio and video data to the cognitive system/server 410 for further analysis. The cognitive system/server 410 could subsequently determine that the user is reading a document and that a true emergency situation is not occurring based on the way in which the trigger statement was said combined with the additional audio and video data before and after the trigger statement was made).

Upon determination of a trigger recognition that could indicate an emergency, the obtained speech and sound data, as well as any associated camera and/or video data can be transmitted to the cognitive system/server 410. The user device 405 can include a temporary storage buffer (e.g., 2 minutes of data storage) for storing audio and visual data on personal datastore 475. Accordingly, if a trigger is detected by trigger verification engine 409, data, which can include audio and visual data leading up to a potential emergency situation, can be transmitted from the temporary storage buffer to the cognitive system/server 410 for analysis. The buffer may be constantly overwritten if no triggers are detected by trigger verification engine 409. The cognitive system/server 410 can perform further analysis on received speech, sound, camera and/or video data to verify that an emergency is occurring. The datastore 430 can store sound clips associated with an emergency. The sound clips could be known sounds heard in emergency situations as well as other trigger sounds that may not indicate an emergency situation. The emergency sound clips could be certain types of screams that indicate fear or pain, broken glass, gunshots, thump made when falling, etc., and the trigger sound clips that may not indicate an emergency could be cheerful yelling at a sporting event or a gasp while watching a movie. In addition, a frequency difference between a fearful scream and a cheerful scream can be detected by sound analyzer 415 and/or the conjunction of a scream with other sounds may be used to identify an emergency. The sound analyzer 415 can include speech analysis software and the visual analyzer 418 can include video recognition software (e.g. Watson related APIs—Natural Language Classifier API, Natural Language Understanding API, Personality Insights API, Knowledge Studio API, Watson Discovery API, Tone Analyzer API, Speech to Text API, Visual Recognition API produced by IBM), which can be used by the cognitive system/server 410 to determine what was said or heard by an associated user device 405 using natural language processing (NLP) techniques and performing linguistic analysis to determine emotion and sentiment. The cognitive system/server 410 can additionally utilize any associated sensor data and/or biometric data in the analysis of verifying that an emergency situation is occurring.

Accordingly, the cognitive system/server 410 can detect fear or sadness in a user's tone in order to determine whether an emergency situation is occurring. The cognitive system/server 410 can generate and associate a timestamp and/or location (using GPS 470 on user device 405) upon the verification that an emergency situation is occurring.

Upon the verification that an emergency situation is occurring by the cognitive system/server 410, the cognitive system/server 410 can determine an emergency type. An alert notification engine 420 can generate an alert for the emergency, which may include any of audio, video, timestamp, and/or location information. The cognitive system/server 410 can use the determined emergency type to determine which emergency services entity 440 the alert should be sent to, if at all. The cognitive system/server 410 can also access contact information for a user stored on personal datastore 475 of user device 405 and can contact one or more designated emergency contacts.

Also, speakers 460 associated with the user device 405 and/or peripherals 480 can be used to play alert sounds if necessary (depending on the type of emergency) in an attempt to ward off a criminal or draw attention of people nearby to the user/emergency.

Also, if the user device 405 is coupled to a vehicle, the cognitive system/server 410 can instruct the vehicle to indicate that an emergency is occurring via one or more vehicle components (e.g., the vehicle can turn on headlights, horn, and/or cameras (to possibly capture the event). If the vehicle is autonomous or semi-autonomous, the vehicle can be instructed to reposition itself in order point the vehicle's headlights towards the emergency situation and/or to capture information related to the emergency situation.

In addition, if a camera 455 associated with the user device 405 is not on during a determined occurrence of the emergency, the cognitive system/server 410 can activate the camera 455 of the user device 405 to obtain additional camera and/or video data about the emergency for use by the emergency services 440 or for future training of the cognitive system/server 410. It is recognized that the user device 405 may not capture useful data if it is in the user's purse, pocket, etc.

The user device 405 can also be operably coupled to public and private entities to obtain visual and audio data during an emergency (e.g., a building or town/city/municipality can allow access to associated security and/or street cameras to obtain additional data. Accordingly, the cognitive system/server 410 can use the additional information to verify that an emergency is occurring.

Also, the user device 405 is capable of performing some or all aspects of the functionality associated with the alert notification system 420. Accordingly, the user device 405 can also verify that an emergency is occurring and notify local authorities and/or emergency services when communications between the user device 405 and the cognitive system/server is unavailable or impractical. In some embodiments, a trigger detected by trigger verification engine 409 may indicate a need to contact emergency services without the need for further analysis by the cognitive system/server 410 (e.g., a gunshot detected at a GPS location in the middle of a city or town).

The network(s) 450 can include, but are not limited to, any one or a combination of different types of suitable communications networks such as, for example, cable networks, public networks (e.g., the Internet), private networks, wireless networks, cellular networks, or any other suitable private and/or public networks. Further, the network(s) 450 can have any suitable communication range associated therewith and can include, for example, global networks (e.g., the Internet), metropolitan area networks (MANs), wide area networks (WANs), local area networks (LANs), or personal area networks (PANs). In addition, the network(s) 450 can include any type of medium over which network traffic can be carried including, but not limited to, coaxial cable, twisted-pair wire, optical fiber, a hybrid fiber coaxial (HFC) medium, microwave terrestrial transceivers, Bluetooth, and/or a wireless network radio (such as a radio capable of communication with a wireless communication network such as a Long Term Evolution (LTE) network, WiMAX network, 3G network, etc.), satellite communication mediums, or any combination thereof.

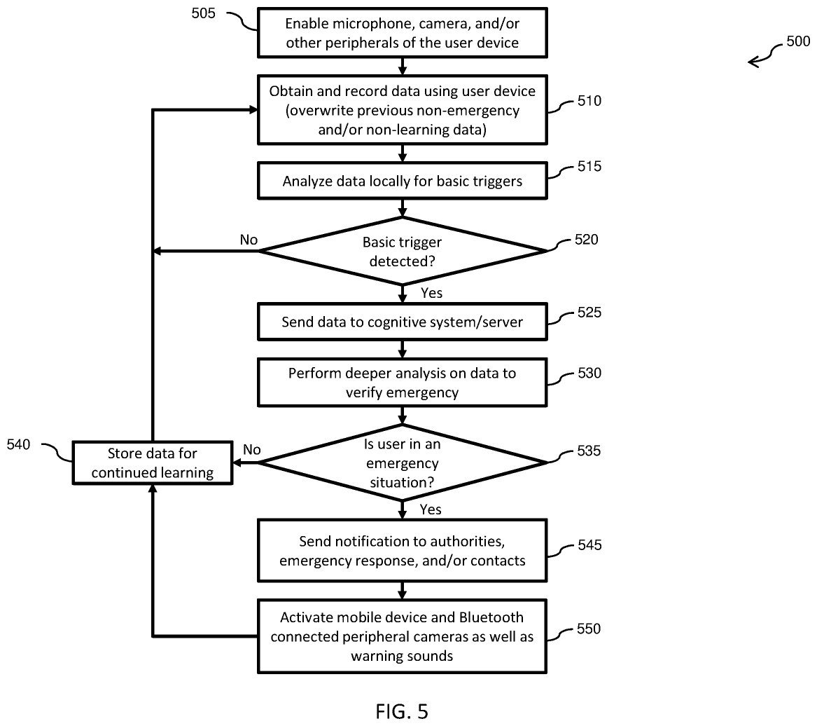

Now referring to FIG. 5, a flow diagram of a method 500 for determining and providing an alert notification that an emergency is occurring in accordance with one or more embodiments of the present invention. At block 505, a microphone and/or camera can be activated/enabled to obtain speech, sounds, pictures and/or video data from a user device, for example, user device 405. The activation of the microphone and/or camera can occur, for example, when the user device turns on (i.e., enabled all the time), when an emergency assistance application automatically launches in order to enable one or more of these features for the user device and connected peripherals, or when the user launches the emergency assistance application. The user device can be operably coupled to a vehicle using, for example, Bluetooth. At block 510, the user device can use the microphone, the camera, as well as sensors to obtain data (e.g., speech, sound, picture, video, biometric, physical activity data or the like, for analysis). The user device can include a temporary storage buffer that can be overwritten with newly recorded data if an emergency is not detected and/or there is no useful learning data.

At block 515, the user device can analyze the obtained data to determine if the data indicates a basic trigger indicating that an emergency may be occurring. The analysis can entail comparing the obtained data to stored emergency trigger data (i.e., words, expressions, sounds, images, or other indications of an emergency). The emergency triggers can be adapted over a learning period to adjust to a particular user based on their typical mannerisms, vocal patterns, and what they experience daily. The analysis by the user device can be a preliminary assessment of whether an emergency may be occurring in which further analysis that would be processor intensive may be needed. At block 520, if the user device has determined that a basic trigger has not been encountered in response to the comparison, method 500 returns to block 510.

If the user device has determined that an emergency trigger has been encountered in response to the comparison, the method 500 proceeds to block 525 where the user device can send/transmit the obtained data (e.g., last 30 seconds or 1 minute of data leading up to a detected basic trigger) to a computing system (e.g., a server/cloud server) for further processing using, for example, a temporary memory buffer on the user device. At block 530, the computing system can perform additional analysis (e.g., speech analysis software and video recognition software using one or more Watson APIs, as well as sound analysis and biometric data to verify that an emergency is occurring. For example, the computing system can analyze the obtained data for sounds related to screams that indicate fear or pain, broken glass, gunshots, thump made when falling, etc. Also, the computing device can further analyze screams/yells to determine if the screams indicate an emergency or a non-emergency event (e.g. a scream of joy, a scream at a sporting event, etc.). The screams/yells can be compared to recorded screams/yells stored in a user's personal datastore that do not indicate fear (e.g., yelling at a sporting event or if cut off in traffic). If a similar frequency in the screams/yells is detected, and no other background sounds indicate an emergency (e.g., other fans are cheering, typical vehicle noise or radio detected after the screams/yells), the analysis can determine that an emergency is not occurring. If a higher pitch scream/yell (i.e., higher frequency) than normal (i.e., the recorded screams/yells stored in the user's personal datastore that do not indicate fear) and/or the scream/yell is in the combination of other detected background sounds (e.g., heavy breathing after yell, loud sounds, etc.) the analysis can determine that an emergency is occurring.

At block 535, if the further analysis indicates that an emergency situation is not occurring, the method 500 proceeds to block 540 where the received data can be stored for an iterative learning process performed by the computing system to better determine the occurrence of non-emergencies. If the further analysis indicates that an emergency situation is occurring, the method 500 proceeds to block 545 where a notification of the emergency can be sent to emergency services, as well as one or more designated emergency contacts. At block 550, the computing system can instruct the user device to activate an associated camera, a GPS receiver/transceiver, and other sensors in order to obtain further information related to the occurring emergency if not already enabled.

If the user device is connected to a vehicle, one or more vehicle components (e.g., headlights, horn, and/or cameras) can be enabled to possibly capture the event, scare an attacker and/or bring attention to an emergency situation. If the vehicle is autonomous or semi-autonomous, the vehicle can be instructed to reposition itself in order point the vehicle's headlights towards the emergency situation and/or to capture information related to the emergency situation. In some embodiments, additional resources not controlled by the user (e.g., store cameras, city camera, etc.) can be accessed to retrieve additional information about an emergency situation.

Accordingly, a system, a method, and/or computer program product disclosed herein can determine if an individual is in an emergency situation and can notify local authorities and/or contacts that the individual is involved in an emergency situation. Using sensors and devices of a user device in conjunction with a cognitive system/server (such as Watson), which can include speech analysis software and video recognition software can perform additional analysis to determine whether the user is in danger according to speech patterns, external noises, and other user defined parameters. In addition to speech and video, biometric data such as heartrate, physical movements, etc., can be used as additional inputs to determine if the user is in an emergency situation. The cognitive system/server can contain an internal storage that stores a database of sound clips of known sounds heard in emergency situations as well as other trigger sounds and images that may not indicate an emergency situation, which can be compared to input received from the user device when conducting a further analysis to determine if the user is in an emergency situation. The system can be tailored to the specific user based on their typical mannerisms, vocal patterns, and what they experience daily.

Once the system detects that a user is involved in an emergency event, a series of actions can be taken: a timestamp and report of the event is stored, a camera associated with the user device can be activated to begin/continue recording, the recording as well as continued audio files can be live streamed to a cloud server, local authorities, and/or emergency services that are within the area and personal contacts can be notified, and siren/warning sounds and visual indicators (e.g., flashing lights) can be played through the user device and peripheral devices in an attempt to scare the perpetrator and/or attract the attention of others nearby. Accordingly, emergency situations can be detected more quickly thereby allowing for a quicker response to the emergency by local authorities and emergency services. The quicker response can therefore provide a better chance for avoiding serious injury or lasting effects due to the emergency and may provide evidence if a trial ensues.

Accordingly, the system described herein can perform a high-level screening for emergency situations on a user device which determines if deeper analysis is needed to be performed on a remote computing system in order to determine if emergency is actually occurring. By performing the deeper analysis, which is processor intensive, on the remote computing system, the deeper analysis can be performed faster thereby alerting emergency services to occurring emergencies faster.

The present invention may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for determining that an emergency situation is occurring, the method comprising:
receiving, using a processor, audio and/or video data from a user device;
analyzing, using the processor, the audio and/or video data for triggers indicating an emergency;
determining, using the processor, that an emergency is occurring in response to the analysis indicating a trigger within the audio and/or video data; and
in response to the analysis indicating a trigger within the audio and/or video data, transmitting the audio and/or video data and a content of a buffer to a remote computing system for further analysis, wherein the content of the buffer includes audio and/or video covering a time period before the trigger in the audio and/or video data.

2. (canceled)

3. The computer-implemented method of claim 1, wherein the further analysis uses speech analysis software and video recognition software to verify that an emergency is occurring based on the received audio and/or video data.

4. The computer-implemented method of claim 3, further comprising notifying local authorities and/or emergency services in response to the further analysis verifying that an emergency is occurring.

5. The computer-implemented method of claim 3, further comprising notifying one or more emergency contacts in response to the further analysis verifying that an emergency is occurring.

6. The computer-implemented method of claim 1, further comprising instructing the user device to activate an associated camera, microphone and/or peripheral device and/or control a vehicle and/or one or more vehicle components.

7. The computer-implemented method of claim 6, wherein the camera and microphone are used to obtain additional information related to the emergency occurring.

8. A computer program product, the computer program product comprising a computer readable storage medium having program instructions embodied therewith, the program instructions readable by a processing circuit to cause the processing circuit to:
receive audio and/or video data from a user device;
analyze the audio and/or video data for triggers indicating that an emergency;
determine that an emergency is occurring in response to the analysis indicating a trigger within the audio and/or video data; and
in response to the analysis indicating a trigger within the audio and/or video data, transmitting the audio and/or video data and a content of a buffer to a remote computing system for further analysis, wherein the content of the buffer includes audio and/or video covering a time period before the trigger in the audio and/or video data.

9. (canceled)

10. The computer program product of claim 8, wherein the further analysis uses speech analysis software and video recognition software to verify that an emergency is occurring in response based on the received audio and/or video data.

11. The computer program product of claim 10, further comprising notifying local authorities and/or emergency services in response to the further analysis verifying that an emergency is occurring.

12. The computer program product of claim 10, further comprising notifying one or more emergency contacts in response to the further analysis verifying that an emergency is occurring.

13. The computer program product of claim 8, further comprising instructing the user device to activate an associated camera, microphone and/or peripheral device and/or control a vehicle and/or one or more vehicle components.

14. The computer program product of claim 13, wherein the camera and microphone are used to obtain additional information related to the emergency occurring.

15. A computer system, comprising:
a processor in communication with one or more types of memory, the processor configured to:
receive audio and/or video data from a user device;
analyze the audio and/or video data for triggers indicating that an emergency;
determine that an emergency is occurring in response to the analysis indicating a trigger within the audio and/or video data; and
in response to the analysis indicating a trigger within the audio and/or video data, transmitting the audio and/or video data and a content of a buffer to a remote computing system for further analysis, wherein the content of the buffer includes audio and/or video covering a time period before the trigger in the audio and/or video data.

16. (canceled)

17. The computer system of claim 15, wherein the further analysis uses speech analysis software and video recognition software to verify that an emergency is occurring in response based on the received audio and/or video data.

18. The computer system of claim 17, wherein the processor is further operable to notify local authorities and/or emergency services in response to the further analysis verifying that an emergency is occurring.

19. The computer system of claim 17, wherein the processor is further operable to notify one or more emergency contacts in response to the further analysis verifying that an emergency is occurring.

20. The computer system of claim 15, wherein the processor is further operable to instruct the user device to activate an associated camera, microphone and/or peripheral device and/or control a vehicle and/or one or more vehicle components.
